(19) United States
(12) Patent Application Publication
(10) Pub. No.: US 2025/0102664 A1
(43) Pub. Date: Mar. 27, 2025

(54) COMPUTER DEVICE AND METHOD FOR EXAMINING A RADAR SYSTEM EQUIPPED WITH AT LEAST TWO TRANSMITTING AND RECEIVING UNITS WHICH EACH COMPRISE AT LEAST ONE RESPECTIVE ANTENNA ELEMENT

(71) Applicant: Robert Bosch GmbH, Stuttgart (DE)

(72) Inventors: Daniel Schindler, Korntal-Münchingen (DE); Tobias Schmid, Fluorn-Winzeln (DE); Benedikt Loesch, Stuttgart (DE); Johannes Fink, Karlsruhe (DE); Werner Soergel, Pforzheim (DE)

(21) Appl. No.: 18/796,660

(22) Filed: Aug. 7, 2024

(30) Foreign Application Priority Data
Sep. 22, 2023 (DE) 10 2023 209 256.5

(51) Int. Cl. G01S 13/87; G01S 7/40

(52) U.S. Cl. CPC G01S 13/878; G01S 7/4004

(57) ABSTRACT

A computer device and a method for examining a radar system equipped with at least two transmitting and receiving units which each include at least one respective antenna element. The method includes: defining at least one probability distribution for at least one object with respect to a probable position of the respective object in an angular spectrum based on radar signals transmitted by the at least two transmitting and receiving units, reflected on the at least one object and received by the transmitting and receiving units, determining an average width of the probability distributions in the angular spectrum defined within a given time interval and within a given angular range of the angular spectrum, and defining position information relating to a displacement of at least one of the transmitting and receiving units out of its respective target position taking into account the determined average width.

### CROSS REFERENCE

The present application claims the benefit under 35 U.S.C. § 119 of German Patent Application No. DE 10 2023 209 256.5 filed on Sep. 22, 2023, which is expressly incorporated herein by reference in its entirety.

### FIELD

The present invention relates to a computer device for a radar system equipped with at least two transmitting and receiving units which each comprise at least one respective antenna element and a radar system. The present invention also relates to a method for examining a radar system equipped with at least two transmitting and receiving units which each comprise at least one respective antenna element. The present invention also relates to a method for operating a radar system equipped with at least two transmitting and receiving units which each comprise at least one respective antenna element and a method for determining surroundings information relating to at least a part of the surroundings of a radar system equipped with at least two transmitting and receiving units which each comprise at least one respective antenna element.

### BACKGROUND INFORMATION

Radar sensor systems, in particular cooperative radar sensor systems, are described in, for example, German Patent Application No. DE 10 2019 220 238 A1.

### SUMMARY

The present invention provides a computer device for a radar system equipped with at least two transmitting and receiving units which each comprise at least one respective antenna element, a radar system, a method for examining a radar system equipped with at least two transmitting and receiving units which each comprise at least one respective antenna, a method for operating a radar system equipped with at least two transmitting and receiving units which each comprise at least one respective antenna element, and a method for determining surroundings information relating to at least a part of the surroundings of a radar system equipped with at least two transmitting and receiving units which each comprise at least one respective antenna element.

The present invention provides advantageous possibilities for detecting a lateral shift/displacement of at least one transmitting and receiving unit of a radar system equipped with at least two transmitting and receiving units which each comprise at least one respective antenna element out of its respective given target alignment. The present invention can thus be used to identify incorrect assembly of the at least two transmitting and receiving units of the respective radar system, damage to the radar system, for example by mechanical contact with a foreign object, and/or impairment of the respective radar system due to environmental influences, in particular such as heat or wind pressure on the bumper. The present invention can then also be used to implement measures by means of which the lateral shift/displacement of the at least one transmitting and receiving unit can be rectified and/or compensated with the aid of a correspondingly adapted operation of the respective radar system. The present invention can therefore not only be used to detect lateral shift/displacement of the at least one transmitting and receiving unit of the respective radar system, but also to react advantageously to the detected error. The present invention thus contributes to improving the operation of the respective radar system and increasing its service life.

In one advantageous example embodiment of the computer device of the present invention, in which the target positions of the at least two transmitting and receiving units are located in a plane aligned parallel to the gravitational axis, the electronic device is designed and/or programmed in such a way that the electronic device can be used to define information relating to a displacement of at least one of the at least two transmitting and receiving units out of its respective target position along a first spatial axis which lies within the given plane and is aligned parallel to the gravitational axis as at least part of the position information. Alternatively or additionally, the electronic device can be designed and/or programmed in such a way that the electronic device can be used to define information relating to a displacement of at least one of the at least two transmitting and receiving units out of its respective target position along a second spatial axis which lies within the given plane and is aligned perpendicular to the gravitational axis as at least part of the position information. The electronic device can also be used to define information relating to a displacement of at least one of the at least two transmitting and receiving units out of its respective target position along a third spatial axis which lies within the given plane and is aligned perpendicular to the given plane as at least part of the position information. This means that even a three-dimensional lateral shift/displacement of the at least one transmitting and receiving unit of the radar system can be reliably detected by means of the computer device and/or quantitatively expressed by means of a corresponding physical quantity.

According to an example embodiment of the present invention, the electronic device is preferably designed and/or programmed in such a way that the electronic device can be used to output at least one control signal for at least one of the transmitting and receiving units to a separate displacement device of the respective transmitting and receiving unit taking into account the defined position information in such a way that a respective actual position of the respective transmitting and receiving unit can be set by means of the controlled displacement device in accordance with the respective target position. The lateral shift/displacement of the at least one transmitting and receiving unit of the radar system can thus be rectified again without human effort.

As another advantageous further development of the present invention, the electronic device can also designed and/or programmed in such a way that the electronic device can be used to define surroundings information relating to at least the part of the surroundings of the radar system taking into account a large number of radar signals transmitted and received by the at least two transmitting and receiving units and additionally taking into account a given evaluation program, wherein the electronic device can be used to redefine the evaluation program taking into account the defined position information. Redefining the evaluation program makes it possible to adapt the evaluation of the radar signals to a detected lateral shift/displacement of the at least one transmitting and receiving unit of the radar system in such a way that reliable operation of the radar system continues to be assured.

A radar system according to the present invention comprising a corresponding computer device and the at least two transmitting and receiving units which each comprise at least one respective antenna element also has the above-described advantages. The radar system can be a radar sensor system, for instance, and/or a cooperative radar sensor system. The radar system can therefore also be a system comprising an evaluation unit and various remote antenna arrays with transmitting and receiving antennas, for example, or a central computing unit and comprising such antenna arrays. The radar system can similarly also be a COOP system that includes a variety of synchronized radar sensors.

Carrying out a corresponding method for examining a radar system equipped with at least two transmitting and receiving units which each comprise at least one respective antenna element likewise also brings about the advantages discussed above. It should be noted that the method can be further developed in accordance with the above-described embodiments of the computer device of the present invention.

For example, when carrying out the method of the present invention, a first average width of probability distributions defined using a particular one of the at least two transmitting and receiving units and a second average width of probability distributions defined without using the particular transmitting and receiving unit can be determined, wherein the position information relating to a displacement of the particular transmitting and receiving unit out of its target position is defined taking into account the first average width and the second average width. A comparison of the first average width with the second average width can in particular be used to reliably detect whether the (concomitant) use of the particular transmitting and receiving unit leads to a “deterioration/enlargement” of the average width.

A method according to the present invention for operating a radar system equipped with at least two transmitting and receiving units which each comprise at least one respective antenna element and a method for determining surroundings information relating to at least a part of the surroundings of a radar system equipped with at least two transmitting and receiving units which each comprise at least one respective antenna element also provide the above-described advantages. These methods, too, can be further developed in accordance with the above-described embodiments of the computer device of the present invention.

### BRIEF DESCRIPTION OF THE DRAWINGS

Further features and advantages of example embodiments of the present invention are explained in the following with reference to the figures.

FIG. 1Aa to 1Cf show schematic illustrations of a radar system with at least two transmitting and receiving units which each comprise at least one respective antenna element, a flow chart, and coordinate systems for explaining an example embodiment of the method for examining the radar system, according to the present invention.

FIG. 2 shows a flow chart for explaining the method according to an example embodiment of the present invention for operating a radar system equipped with at least two transmitting and receiving units which each comprise at least one respective antenna element.

FIG. 3 shows a flow chart for explaining an example embodiment of the present invention of the method for determining surroundings information relating to at least a part of the surroundings of a radar system equipped with at least two transmitting and receiving units which each comprise at least one respective antenna element.

FIG. 4A to 4C a schematic illustration of a radar system equipped with at least two transmitting and receiving units which each comprise at least one respective antenna element and images of at least a part of the surroundings taken by the radar system for explaining an example embodiment of a computer device of the present invention interacting with it.

### DETAILED DESCRIPTION OF EXAMPLE EMBODIMENTS

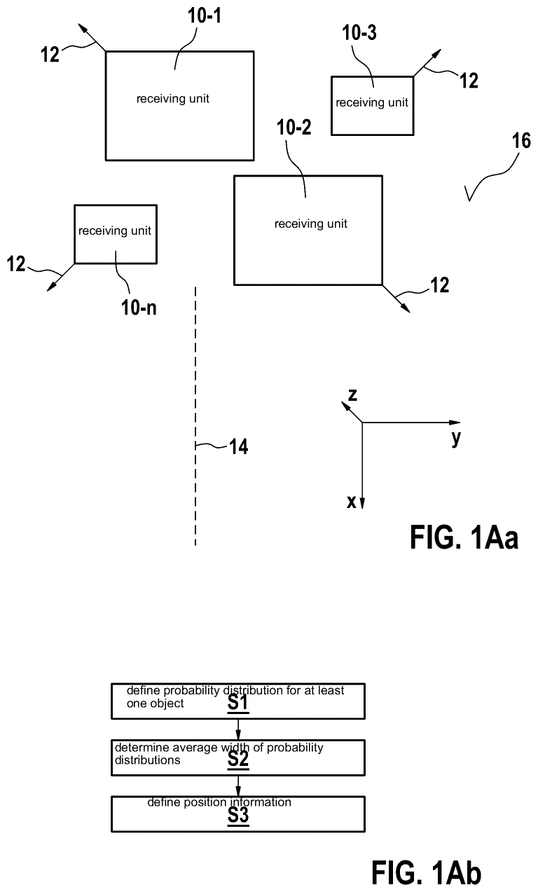

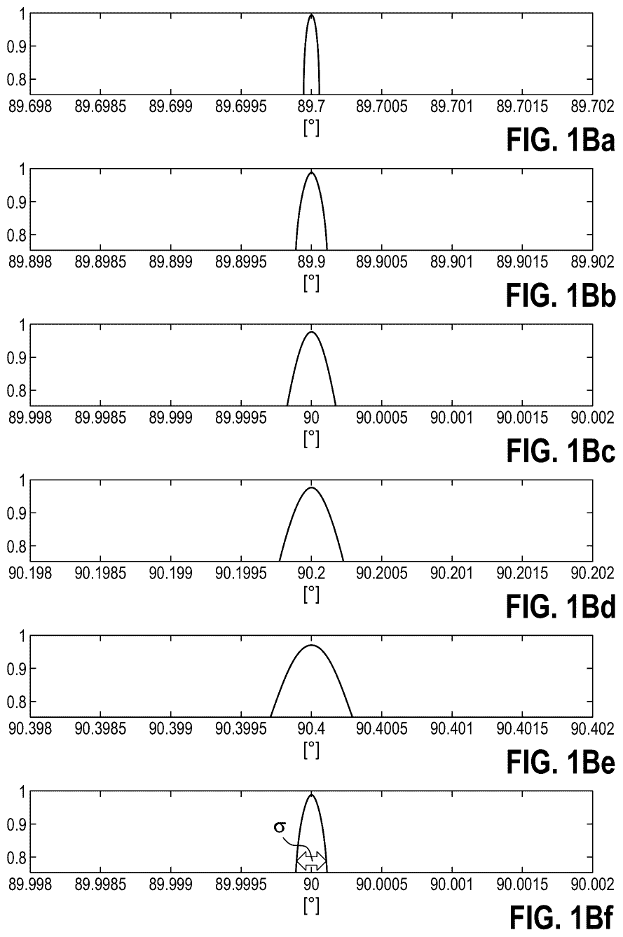

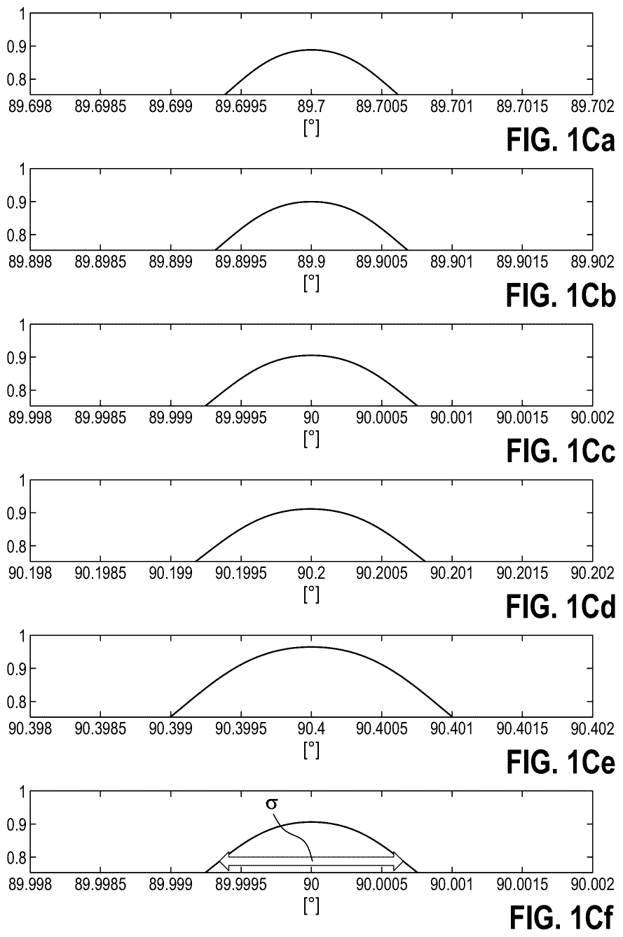

FIG. 1Aa to 1Cf show a schematic illustration of a radar system with at least two transmitting and receiving units which each comprise at least one respective antenna element, a flow chart, and coordinate systems for explaining an embodiment of the method for examining the radar system.

The radar system shown schematically in FIG. 1Aa has at least two transmitting and receiving units 10-1 to 10-n, and each one of the at least two transmitting and receiving units 10-1 to 10-n comprises at least one (not depicted) antenna element. The pictorial representation of exactly four transmitting and receiving units 10-1, 10-2, 10-3 and 10-n in FIG. 1Aa is to be interpreted merely as an example. The at least two transmitting and receiving units 10-1 to 10-n can either have an equal total number of antenna elements (per transmitting and receiving unit 10-1 to 10-n) or the total number of antenna elements (per transmitting and receiving unit 10-1 to 10-n) can differ. However, the at least two transmitting and receiving units 10-1 to 10-n are intended to be understood as units that are preferably each designed/suitable for both transmitting and receiving radar signals.

The at least two transmitting and receiving units 10-1 to 10-n of the radar system are intended to be understood as spatially separate units. The at least two transmitting and receiving units 10-1 to 10-n can be subdevices of the radar system, for instance, that are not mounted on a common carrier. Alternatively, however, the at least two transmitting and receiving units 10-1 to 10-n can also be mounted on a common (not depicted) carrier. The at least two transmitting and receiving units 10-1 to 10-n can alternatively also constitute a cooperative radar sensor system. In a monostatic operation of the radar system, a radar signal transmitted by a single transmitting and receiving unit 10-1 or 10-n is received and evaluated by the same transmitting and receiving unit 10-1 to 10-n after it has been reflected by an object. In a bistatic operation, the radar signal can also be received by a different transmitting and receiving unit 10-1 to 10-n after it has been reflected by the object.

As illustrated in FIG. 1Aa by means of the arrows 12, at least one of the transmitting and receiving units 10-1 to 10-n can also be shifted or displaced out of its given target position. The respective target position of the respective transmitting and receiving unit 10-1 to 10-n can be understood to be a desired position of its phase center or its volume center, for instance. The shift/displacement of at least one of the transmitting and receiving units 10-1 to 10-n out of its given target position, illustrated by means of the arrows 12, can be caused by improper assembly of the radar system, damage to the radar system, in particular as a result of a foreign object hitting at least one of the transmitting and receiving units 10-1 to 10-n, for instance, or by environmental influences, in particular thermal stress.

Any shift/displacement of at least one of the transmitting and receiving units 10-1 to 10-n of the radar system out of its given target position can be reliably detected using the method described in the following and/or determined quantitatively by means of a corresponding physical quantity.

For this purpose, when carrying out the method in a method step S1 (see FIG. 1Ab) when evaluating radar signals transmitted by the at least two transmitting and receiving units 10-1 to 10-n of the radar system, reflected on at least one object and received by the at least two transmitting and receiving units 10-1 to 10-n, at least one probability distribution/correlation curve is defined for the at least one object. The respective curve is obtained using an angle estimation. The at least one object is to be understood to be an object present in at least a part of the surroundings of the radar system. At least part of the surroundings of the radar system can therefore be understood to be a spatial volume that can be “scanned” by means of the radar signals transmitted by the at least two transmitting and receiving units 10-1 to 10-n, and from which reflected radar signals can be received by the at least two transmitting and receiving units 10-1 to 10-n.

When carrying out method step S1, the respective probability distribution is defined in an angular spectrum which represents at least part of the surroundings of the radar system. Preferably, a probability distribution is defined for each target (by spectrum, CFAR, peak detection). The angular distributions of the angular spectrum can be fixed for the radar system or dependent on a variety of conditions. In each case, the probability distribution defined when carrying out method step S1 represents a distribution relating to a probable position of the respective object.

The method step S1 can be carried out as often as necessary, so that a probability distribution is defined for a variety of different objects in at least the part of the surroundings of the radar system. The coordinate systems of FIGS. 1Ba to 1Be and 1Ca to 1Ce each represent such a probability distribution, wherein abscissas of the coordinate systems of FIGS. 1Ba to 1Be and 1Ca to 1Ce indicate an angular range (in) degrees/° and the ordinates indicate an associated probability value.

The coordinate systems of FIG. 1Ba to 1Be represent probability distributions of different objects which are determined by the radar system when all of its transmitting and receiving units 10-1 to 10-n are in their respective target position. The coordinate systems of FIG. 1Ca to 1Ce, on the other hand, show probability distributions of different objects which are determined by the (same) radar system while at least one of the transmitting and receiving units 10-1 to 10-n of the radar system is shifted/displaced out of its given target position. Comparing the coordinate systems of FIGS. 1Ba to 1Be with the coordinate systems of FIGS. 1Ca to 1Ce shows that the shift/displacement of at least one of the transmitting and receiving units 10-1 to 10-n of the radar system out of its given target position leads to an angular enlargement.

In a method step S2 of the method described here, an average width σ of the probability distributions in the angular spectrum defined within a given time interval and within a given angular range of the angular spectrum is determined. To carry out the method step S2, the individual widths σ of the probability distributions defined within the given time interval and within the given angular range can be determined first, for example, and then averaged to obtain the average width α as a result.

Alternatively, the probability distributions in the angular spectrum defined within the given time interval and within the given angular range can first be superimposed. In the embodiment described here, for example, the probability distributions of the coordinate systems of FIGS. 1Ba to 1Be are superimposed on one another in such a way that their measured or plotted maximums are at 90°. The probability distributions of the coordinate systems of FIGS. 1Ca to 1Ce are similarly superimposed on one another in such a way that their measured or plotted maximums are overlaid at 90°, for example. When superimposing the probability distributions, it is preferable that care be taken to ensure that probability distributions for objects that are present in different angular ranges in relation to the radar system are superimposed on one another as well. This makes it possible to ensure that the method described here produces uniform detection or correction in the beampattern and that undesirable “squinting” (due to a preference for certain angular segments) is avoided. Adhering to a given threshold value for the correlation quality of the superimposed probability distributions furthermore makes it possible to ensure that (essentially) only probability distributions for only one respective object are evaluated in the method described here. If the value falls below the given threshold value, it can be assumed with a high probability that the respective probability distribution is based on a “superposition of multiple object peaks”. (Such detections in the distance speed spectrum are therefore not used to detect lateral displacement.)

The superposition of the probability distributions in the angular spectrum can be carried out using equation (Eq. 1) with:

$$μ = \frac{1}{N} * {\sum }_{i = 1}^{N} Ai , \qquad ( Eq . 1 )$$

wherein N is the number of respective superimposed probability distributions.

In the coordinate systems of FIGS. 1Bf and 1Cf, the abscissas represent the angular range (in) degrees/° and the ordinates represent an associated probability value. The coordinate system of FIG. 1Bf shows the superimposed probability distributions of the coordinate systems of FIGS. 1Ba to 1Be. The coordinate system of FIG. 1Cf therefore shows the superimposed probability distributions of the coordinate systems of FIGS. 1Ca to 1Ce.

The average width σ of the respective superimposed probability distributions in the angular spectrum can then be ascertained. As the average width σ, a normal distribution or a Gaussian distribution of the respective superimposed probability distributions is preferably determined. Alternatively, however, a half-width of the respective superimposed probability distributions or a width of the respective superimposed probability distributions at a given value can also be determined as the average width. The average width σ can also be described as an angular enlargement interval of the respective superimposed probability distributions.

Taking into account the determined average width σ, position information relating to a displacement of at least one of the at least two transmitting and receiving units out of its respective target position is then defined in a method step S3. In the method step S3, the determined average width σ can be compared to a given normal value or normal value range, for example, wherein, if the determined average width σ deviates from the given normal value or normal value range, it is determined at least as part of the position information that at least one of the transmitting and receiving units 10-1 to 10-n is shifted/displaced out of its given target position (see FIG. 1Cf). On the other hand, if the determined average width σ is equal to the given normal value or the determined average width σ is within the given normal value range, it can continue to be assumed that all of the transmitting and receiving units 10-1 to 10-n of the radar system are still in their given target positions (see FIG. 1Bf).

As can be seen from a comparison of FIGS. 1Bf and 1Cf, the average width σ increases with (increasing) shift/displacement of the transmitting and receiving units 10-1 to 10-n out of their target positions. When the average width σ is above the given normal value or outside the normal value range, it can therefore reliably be assumed that there is an actually present lateral shift/displacement of at least one of the transmitting and receiving units 10-1 to 10-n out of its respective target position. The average width σ can therefore be used to reliably detect an actually present lateral shift/displacement of at least one of the transmitting and receiving units 10-1 to 10-n out of its respective target position.

For better understanding, it must be said here that, even though only a possible “deterioration” of the average width σ can be measured “directly”, the possible “deterioration” of the mean width σ can be used to determine more precise position information indirectly. Correction matrices, that each correspond to a possible physical displacement of at least one of the transmitting and receiving units 10-1 to 10-n out of its respective target position in a specific direction can be used for this purpose, for instance. Evaluating the detected “deterioration” of the average width σ using the correction matrices then makes it possible to deduce the physical displacement of at least one of the transmitting and receiving units 10-1 to 10-n out of its respective target position that has actually occurred.

Another way of indirectly determining the position information can be described as a “leave one out method”. For this purpose, a first average width σ can be ascertained by (concomitantly) using a particular one of the at least two transmitting and receiving units 10-1 to 10-n while a second average width σ is determined before or after this without using the particular transmitting and receiving unit 10-1 to 10-n. Using the first average width σ and the second average width σ, in particular using a comparison of the first average width σ with the second average width σ, makes it possible to reliably determine whether the particular transmitting and receiving unit 10-1 to 10-n is still (mostly) in its target position. (This is not the case if the comparison of the first average width σ with the second average width σ shows that the particular transmitting and receiving unit 10-1 to 10-n is (at least partly) responsible for a “deterioration” of the average width σ.) The position information can then be defined accordingly. Ascertaining the average width σ based on the radar signals transmitted and received by only some of the transmitting and receiving units 10-1 to 10-n (while not using at least one of the transmitting and receiving units 10-1 to 10-n of the radar system) also makes it possible to purposefully examine which transmitting and receiving unit 10-1 to 10-n is (laterally) shifted/displaced out of its respective target position.

By evaluating the respective average width σ, the respective (lateral) shift/displacement can optionally also be quantitatively expressed using a corresponding physical quantity. In principle, however, the quantitative determination of the corresponding physical quantity is not needed to rectify the physical displacement of at least one of the transmitting and receiving units 10-1 to 10-n out of its respective target position or minimize its effects as described in more detail in the following.

As illustrated in FIG. 1Aa, the target positions of the at least two transmitting and receiving units 10-1 to 10-n can lie in a plane 16 aligned parallel to the gravitational axis 14. (Alternatively, however, the target positions of the at least two transmitting and receiving units 10-1 to 10-n can also lie in a curved plane.) If necessary, the evaluation of the respective average width σ of the respective superimposed probability distributions or the averaged probability distribution determined from the superimposed probability distributions can be used to define information relating to a displacement of at least one of the at least two transmitting and receiving units 10-1 to 10-n out of its respective target position along a first spatial axis x that lies within the given plane 16 and is aligned parallel to the gravitational axis 14 as at least part of the position information. The first spatial axis x can also be understood as a vertical axis. Alternatively or additionally, the evaluation of the respective average width σ can be used to define information relating to a displacement of at least one of the at least two transmitting and receiving units 10-1 to 10-n out of its respective target position along a second spatial axis y that lies within the given plane 16 and is aligned perpendicular to the gravitational axis 14 as at least part of the position information. The second spatial axis y can be described as a horizontal axis. The evaluation of the respective average width σ can also be used to ascertain information relating to a displacement of at least one of the at least two transmitting and receiving units 10-1 to 10-n out of its respective target position along a third spatial axis z that is aligned perpendicular to the given plane 16 as at least part of the position information. In particular a respective first displacement path of at least one of the at least two transmitting and receiving units 10-1 to 10-n out of its respective target position along the first spatial axis x, a respective second displacement path of at least one of the at least two transmitting and receiving units 10-1 to 10-n out of its respective target position along the second spatial axis y and/or a respective third displacement path of at least one of the at least two transmitting and receiving units 10-1 to 10-n out of its respective target position along the third spatial axis y can be determined as position information.

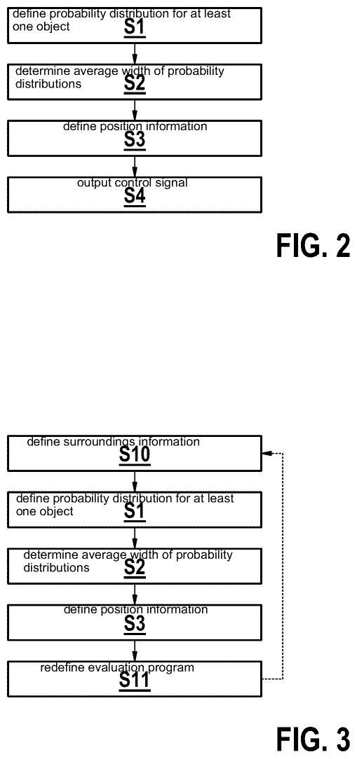

FIG. 2 shows a flow chart for explaining the method for operating a radar system equipped with at least two transmitting and receiving units which each comprise at least one respective antenna element.

In the method described here, at least the method steps S1 to S3 already discussed above are carried out first in order to define the position information. Examples of position information that can be determined in this way have already been listed above.

In a further method step S4, at least one control signal is then output for at least one of the transmitting and receiving units to a separate displacement device of the respective transmitting and receiving unit. The output of the at least one control signal takes into account the respective defined position information in such a way that a respective actual position of the respective transmitting and receiving unit is set by means of the controlled displacement device in accordance with the respective target position. For example, when carrying out the method step S4, at least one of the transmitting and receiving units that has been (laterally) shifted/displaced out of its respective target position can be shifted/displaced back into its desired target position by means of its displacement device. This makes it possible to ensure a performance of the radar system that (essentially) corresponds to the performance that was guaranteed when the radar system was new.

FIG. 3 shows a flow chart for explaining an embodiment of the method for determining surroundings information relating to at least a part of the surroundings of a radar system equipped with at least two transmitting and receiving units which each comprise at least one respective antenna element.

In the method described here, surroundings information relating to at least the part of the surroundings of the radar system is defined in a method step S10 taking into account a large number of radar signals transmitted and received by the radar system. The surroundings information is further defined also taking into account a given evaluation program. A respective distance of at least one object in at least the part of the surroundings of the radar system in relation to the radar system, a relative speed of the at least one object in relation to the radar system and a respective angle of a position of the at least one object in relation to a spatial direction specified for the radar system can be defined as surroundings information, for example. However, the examples listed here for the surroundings information that can be defined should not be construed as limiting.

The evaluation program can be optimized before the radar system is put into operation by means of at least one calibration measurement relating to the radar system. The evaluation program can also include a steering matrix for all of the virtual channels of the radar system, for instance.

During operation of the radar system, at least the method steps S1 to S3 already discussed above are carried out at least once to define the position information.

The evaluation program is then redefined taking into account the defined position information in a further method step S11. Influences and effects of the respective shift/displacement of at least one of the transmitting and receiving units out of its given target position can thus be corrected. When redefining the evaluation program, it is in particular possible to correct the steering matrix for all of the virtual channels in such a way that a correspondingly newly ascertained average width σ is again equal to the given normal value or is once again within the given normal value range. The steering matrix can be corrected using a correction matrix having the same dimension, in which each element of the steering matrix is multiplied element by element with a complex pointer having the length “one” of the correction matrix. Various hypotheses of the correction matrix, in which the lateral shift/displacement of at least one of the transmitting and receiving units is converted into a corresponding phase progression on the different virtual channels, can be set up for the complex pointers of the correction matrix. In order to avoid “trained squinting”, the correction matrix should not be optimized based only on individual angles. It is instead advantageous to use a respective correction matrix for each one of a large number of “test angles” to thus optimize the evaluation program for the large number of “test angles”.

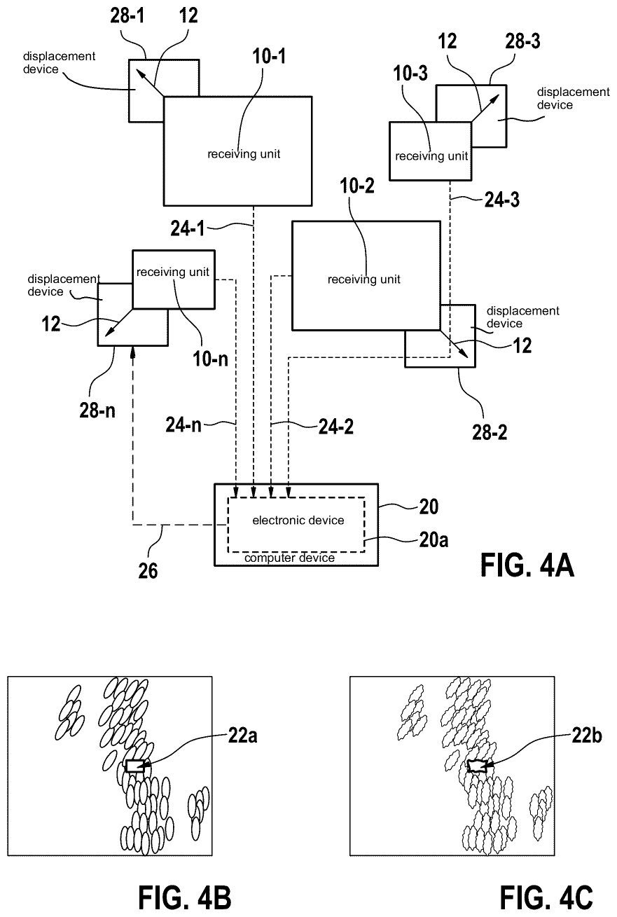

FIG. 4A to 4C show a schematic illustration of a radar system equipped with at least two transmitting and receiving units which each comprise at least one respective antenna element and images of at least a part of the surroundings taken by the radar system for explaining an embodiment of a computer device interacting with it.

The radar system shown schematically in FIG. 4A has at least two transmitting and receiving units 10-1 to 10-n which each comprise at least one respective (not depicted) antenna element. The computer device 20, which is likewise shown schematically in FIG. 4A, can optionally be a subunit of the radar system or a device that is spatially separate from the radar system and interacts with it. The computer device 20 can in particular be an electronic evaluation unit of the radar system. The radar system can be a radar sensor system with remote subarrays, for instance, and/or a cooperative radar sensor system.

As illustrated in FIG. 4A by means of the arrows 12, at least one of the transmitting and receiving units 10-1 to 10-n can also be shifted or displaced out of its given target position. FIG. 4B shows an image taken by the radar system when all of its transmitting and receiving units 10-1 to 10-n are in their respective target position with an object cluster 22a that represents an object in at least a part of the surroundings of the radar system. FIG. 4C, on the other hand, shows an image taken by the (same) radar system with an object cluster 22b representing the same object (in an unchanged position) when at least one of the transmitting and receiving units 10-1 to 10-n of the radar system is shifted/displaced out of its given target position. A comparison of the images of FIGS. 4B and 4C shows that a lateral displacement of at least one of the transmitting and receiving units 10-1 to 10-n of the radar system out of its respective given target position leads to a deterioration of the image sharpness. Another way to describe this is that the lateral displacement of at least one of the transmitting and receiving units 10-1 to 10-n of the radar system out of its respective given target position causes blurring in the angular spectrum, because the evaluation of the radar signal transmitted and received by the at least two transmitting and receiving units 10-1 to 10-n (e.g. by means of the computer device 20) assumes an initial positioning of the transmitting and receiving units 10-1 to 10-n relative to one another that no longer exists. The correlation in the angle estimation, for example by means of DML or Bartlett estimation, is thus degraded. “Signal energy” from a peak at the actual angle of the respective object is therefore “smeared” into adjacent peaks/angles in the correlation result.

The computer device 20 comprises an electronic device 20a, which is designed and/or programmed in such a way that at least one probability distribution for at least one object with respect to a probable position of the respective object in an angular spectrum which represents at least part of the surroundings of the radar system can be/is defined by means of the electronic device 20a based on radar signals transmitted by the at least two transmitting and receiving units, reflected on the at least one object present in at least the part of the surroundings of the radar system and received by the at least two transmitting and receiving units. Data 24-1 to 24-n of the transmitting and receiving units 10-1 to 10-n of the radar system relating to the radar signals transmitted and received by the at least two transmitting and receiving units can be output by the transmitting and receiving units 10-1 to 10-n to the computer device 20/its electronic device 20a.

The electronic device 20a is further designed and/or programmed in such a way that an average width of the probability distributions in the angular spectrum specified within a predetermined time interval and within a predetermined angular range of the angular spectrum can be/is determined by means of the electronic device 20a. Position information relating to a displacement of at least one of the at least two transmitting and receiving units 10-1 to 10-n out of its respective target position can be/is then defined by means of the electronic device 20 taking into account the determined width. Thus the computer device 20 described here also realizes the advantages already discussed above.

As an advantageous further development, the electronic device 20a of the computer device 20 can also be designed/programmed to carry out more of the method steps discussed above. In particular, at least one control signal 26 for at least one of the transmitting and receiving units 10-1 to 10-n can be output/is output by means of the electronic device 20 to a separate displacement device 28a to 28n of the respective transmitting and receiving unit 10-1 to 10-n taking into account the defined position information in such a way that a respective actual position of the respective transmitting and receiving unit 10-1 to 10-n can be set/is set by means of the controlled displacement device 28a to 28n in accordance with the respective target position. The respective displacement device 28a to 28n can be understood to be an actuator, such as an actuator comprising a stepper motor.

What is claimed is:

1. A computer device for a radar system equipped with at least two transmitting and receiving units which each include at least one respective antenna element, the computer device comprising:
an electronic device configured in such a way that the electronic device can be used to define at least one probability distribution for at least one respective object with respect to a probable position of the respective object in an angular spectrum which represents at least part of surroundings of the radar system based on radar signals transmitted by the at least two transmitting and receiving units, reflected on the at least one respective object present in at least a part of the surroundings of the radar system and received by the at least two transmitting and receiving units;
wherein the electronic device configured to:
determine an average width of the probability distributions in the angular spectrum defined within a given time interval and within a given angular range of the angular spectrum, and
define position information relating to a displacement of at least one of the at least two transmitting and receiving units out of its respective target position taking into account the determined width.

2. The computer device according to claim 1, wherein target positions of the at least two transmitting and receiving units are located in a plane aligned parallel to a gravitational axis, and wherein the electronic device is configured to define information relating to a displacement of at least one of the at least two transmitting and receiving units out of its respective target position along a first spatial axis which lies within the plane and is aligned parallel to the gravitational axis as at least part of the position information.

3. The computer device according to claim 1, wherein target positions of the at least two transmitting and receiving units are located in a plane aligned parallel to a gravitational axis, and wherein the electronic device is configured to define information relating to a displacement of at least one of the at least two transmitting and receiving units out of its respective target position along a second spatial axis which lies within the plane and is aligned perpendicular to the gravitational axis as at least part of the position information.

4. The computer device according to claim 1, wherein target positions of the at least two transmitting and receiving units are located in a plane aligned parallel to a gravitational axis, and wherein the electronic device is configured to define information relating to a displacement of at least one of the at least two transmitting and receiving units out of its respective target position along a third spatial axis which is aligned perpendicular to the plane as at least part of the position information.

5. A computer device according to claim 1, wherein the electronic device is configured to output at least one control signal for at least one respective transmitting and receiving unit of the transmitting and receiving units to a separate displacement device of the respective transmitting and receiving unit taking into account the defined position information in such a way that a respective actual position of the respective transmitting and receiving unit can be set using the controlled displacement device in accordance with the respective target position.

6. The computer device according to claim 1, wherein the electronic device is configured to define surroundings information relating to at least the part of the surroundings of the radar system taking into account a large number of radar signals transmitted and received by the at least two transmitting and receiving units and additionally taking into account a given evaluation program, and wherein the electronic device is configured to redefine the evaluation program taking into account the defined position information.

7. A radar system, comprising:
at least two transmitting and receiving units which each include at least one respective antenna element; and
a computer device including an electronic device configured in such a way that the electronic device can be used to define at least one probability distribution for at least one respective object with respect to a probable position of the respective object in an angular spectrum which represents at least part of surroundings of the radar system based on radar signals transmitted by the at least two transmitting and receiving units, reflected on the at least one object present in at least a part of the surroundings of the radar system and received by the at least two transmitting and receiving units,
wherein the electronic device configured to:
determine an average width of the probability distributions in the angular spectrum defined within a given time interval and within a given angular range of the angular spectrum, and
define position information relating to a displacement of at least one of the at least two transmitting and receiving units out of its respective target position taking into account the determined width.

8. The radar system according to claim 7, wherein the radar system is a radar sensor system and/or a cooperative radar sensor system.

9. A method, comprising:
examining a radar system equipped with at least two transmitting and receiving units which each include at least one respective antenna element, by:
defining at least one probability distribution for at least one respective object present in at least a part of the surroundings of the radar system with respect to a probable position of the respective object in an angular spectrum which represents at least part of the surroundings of the radar system based on radar signals transmitted by the at least two transmitting and receiving units, reflected on the at least one respective object and received by the at least two transmitting and receiving units,
determining an average width of the probability distributions in the angular spectrum defined within a given time interval and within a given angular range of the angular spectrum, and
defining position information relating to a displacement of at least one of the at least two transmitting and receiving units out of its respective target position taking into account the determined width.

10. The method according to claim 9, wherein a first average width of probability distributions defined using a particular one of the at least two transmitting and receiving units and a second average width of probability distributions defined without using the particular transmitting and receiving unit are determined, and wherein the position information relating to a displacement of the particular transmitting and receiving unit out of its target position is defined taking into account the first average width and the second average width.

11. The method according to claim 9, further comprising:
outputting at least one control signal for at least one respective transmitting and receiving unit of the transmitting and receiving units to a separate displacement device of the respective transmitting and receiving unit taking into account the defined position information in such a way that a respective actual position of the respective transmitting and receiving unit can be set using the controlled displacement device in accordance with the respective target position.

12. The method according to claim 9, further comprising:
defining surroundings information relating to at least a part of surroundings of the radar system taking into account of a large number of radar signals transmitted and received by the at least two transmitting and receiving units and additionally taking into account a given evaluation program; and
redefining the evaluation program taking into account the defined position information.
